(19) United States
(12) Patent Application Publication
(10) Pub. No.: US 2014/0261117 A1
(43) Pub. Date: Sep. 18, 2014

(54) METERING APPARATUS AND METHOD FOR SECTIONAL CONTROL

(71) Applicant: Salford Farm Machinery Ltd., Salford (CA)

(72) Inventors: Geof J. Gray, Woodstock (CA); Johan Braun Friesen, Tillsonburg (CA); John Mark Averink, Norwich (CA)

(21) Appl. No.: 14/198,584

(22) Filed: Mar. 5, 2014

Related U.S. Application Data
(60) Provisional application No. 61/776,781, filed on Mar. 12, 2013.

(51) Int. Cl. A01C 7/12; A01C 7/08

(52) U.S. Cl. CPC A01C 7/127; A01C 7/081
USPC 111/174; 111/178

(57) ABSTRACT

A metering apparatus for distributing an agricultural product in a field has a drive input and a plurality of rotating metering elements coupled to the drive input. Each of the metering elements rotates around an axis of rotation and at least two of the metering elements rotate around different axes of rotation, preferably on different shafts. Agricultural product is provided to the rotating metering elements, which meter the agricultural product to an agricultural product distribution system on a distribution implement. The axes of rotation of the metering elements are preferably oriented non-transversely, preferably longitudinally, on the metering apparatus in relation to the direction of forward motion of the implement. When the metering apparatus is used on an air cart, the axes of rotation of the metering elements are preferably oriented parallel to the air flow into which the product is being metered. Such a side-by-side arrangement of metering elements permits better and simpler control over individual metering elements.

### CROSS REFERENCE TO RELATED APPLICATIONS

This application claims the benefit of U.S. Patent Application 61/776,781 filed on Mar. 12, 2013, which is incorporated herein by reference.

### FIELD OF THE INVENTION

This invention relates to metering apparatuses and methods for agricultural product.

### BACKGROUND OF THE INVENTION

Implements for distributing agricultural product (e.g. seed, fertilizer, etc.) in a field are generally towed behind a tractor or other vehicle. Such implements include one or more ground engaging tools for opening the ground to provide a path in which the agricultural product is deposited. Deposition is accomplished by a system for distributing the agricultural product generally from a single large bin through various lines and ports to be finally deposited on the ground through an outlet port. Following the deposition of the agricultural product, packers cover the deposited agricultural product with soil.

An air cart is one system for distributing agricultural product. An air cart comprises one or more large bins for holding one or more different types of agricultural product, an airflow source (e.g. a fan) and lines or hoses through which agricultural product is carried by the airflow to outlets located at or near the ground engaging tools of the implement. The product passes through the outlet to be deposited on the ground. There are typically a plurality of lines, hoses and ports, one outlet port associated with each ground engaging tool in order to apply product in a regular pattern to large areas of land in a single pass of the implement.

In air carts, proper metering of agricultural product into the airflow is desired to regularize the amount of product delivered to the outlets over time in order to reduce over- or under-deposition of the product in a particular area. Air carts traditionally employed single auger hoppers in which one very large (1-2 feet long) rotating auger distributed agricultural product from the hopper into a single airstream. Such arrangements are still used today by some manufacturers, for example Amity. Single auger air carts suffer from a number of problems. First, either the auger is on or off so agricultural product is either delivered across the entire implement or not delivered at all anywhere on the implement. Thus, fine control over sectional metering is impossible. Second, agricultural product must be metered into an initial large 5″ line, and then split into 2.5″ lines followed by another split into 1″ lines. This creates more complexity as secondary splitters are required and provides less control in how product is transported around the distribution system. Third, it is impossible to distribute more than one kind of product at the same time.

Fine sectional control is desirable because passage of the implement over soil that has already received agricultural product (e.g. the headland) would result in waste of product; therefore, it is desirable to shout off distribution to parts of the implement that are passing over such soil. In an effort to solve this problem, metering apparatuses are preferably equipped with sectional shutoff capabilities to selectively stop deposition of product at parts of the implement passing over already serviced soil. Metering apparatuses for this purpose are known in the art, for example as disclosed in US 2012/0325131 published Dec. 27, 2012, U.S. Pat. No. 8,132,521 issued Mar. 13, 2012, U.S. Pat. No. 8,141,504 issued Mar. 27, 2012 and U.S. Pat. No. 8,196,534 issued Jun. 12, 2012, the entire contents of all of which are herein incorporated by reference. Such metering apparatuses generally involve a meter roller assembly in which a plurality of meter rollers is rotated on a common shaft, the rollers rotating around a transverse axis relative to the motion of the distribution implement. In such an arrangement, sectional control of the meter rollers to prevent distribution of product to certain parts of the implement is problematic. Complicated clutching mechanisms or inefficient gating mechanisms have all been used as described in the aforementioned prior art apparatuses. Further, servicing and repair of individual meter rollers is difficult and time consuming as the entire meter roller assembly needs to be dismantled to service just one part.

There remains a need for a more efficient metering apparatus for agricultural product.

### SUMMARY OF THE INVENTION

There is provided a metering apparatus for distributing an agricultural product, comprising: a drive input; and, a plurality of metering elements coupled to the drive input to be rotatably driven by the drive input, each of the metering elements rotating around an axis of rotation and at least two of the metering elements rotating around different axes of rotation.

There is further provided a metering apparatus for distributing an agricultural product, comprising: a drive input; and, a plurality of metering elements coupled to the drive input to be rotatably driven by the drive input, each of the metering elements rotating around a separate axis of rotation and at least two of the metering elements rotating around axes of rotation that are parallel to one another. The axes of rotation of the at least two metering elements may be parallel to a longitudinal axis of the apparatus.

There is further provided an agricultural product distribution system comprising a metering apparatus of the present invention.

There is further provided a method of distributing an agricultural product in a field using a distribution implement, comprising: providing agricultural product to a plurality of rotating metering elements, each of the metering elements rotating around an axis of rotation and at least two of the metering elements rotating around different axes of rotation, each rotating metering element metering the agricultural product in an agricultural product distribution system on the distribution implement; and, distributing the agricultural product to the field.

The metering elements may be rotated at the same speed or at different speeds. The rotational speed of a given metering element may be selected according to a lateral position of the metering element on the apparatus. There may be a drive input provided for each metering element, a subset of the total number of metering elements, or a single drive input for all metering elements. The metering elements may be separately engageable with the drive input. The metering elements may be separately engageable with the drive input through use of a clutch. The clutch may be electrically actuated. The drive input may comprise an endless chain or belt. Each metering element may comprise a sprocket and the endless chain or belt may follow a serpentine path among the sprockets. Each metering element may be removable from the apparatus in a direction opposite the drive input. Each metering element may be separately removable. The drive input may comprise a hydraulic motor, an electric motor or a ground driven wheel that is caused to rotate by forward movement of the metering apparatus along the field.

The metering apparatus and distribution system have a longitudinal axis in the direction of forward (or backward) motion of an agricultural product distribution implement as it is being towed across the ground. The longitudinal axis runs from front to rear (or rear to front) of the metering apparatus and distribution system. The metering apparatus and distribution system have a transverse axis that is perpendicular to the longitudinal axis and runs side to side (left to right or right to left) of the metering apparatus and distribution system.

The axes of rotation of individual metering elements are preferably parallel to each other. Preferably every metering element rotates around a different axis of rotation. Preferably, each metering element is rotated on a separate shaft so that there is one metering element per shaft. It is also possible to have a metering segment comprising at least two metering elements rotating around any given axis of rotation. Where metering segments are used, the at least two metering elements of the metering segment may be rotated on a same shaft, while each of the metering segments are rotated on a separate shaft.

The axes of rotation of the metering elements are preferably oriented non-transversely. Preferably, the axes of rotation are oriented longitudinally, i.e. perpendicular to the transverse axis of the metering apparatus. There may be one row of metering elements where the metering elements are side by side, for example one transverse row with metering elements side by side in a transverse direction. There may be two or more longitudinally spaced-apart rows of metering elements. If there are two or more rows of metering elements, longitudinally spaced-apart metering elements may rotate around the same or different axes and, if two or more longitudinally spaced-apart metering elements rotate on the same axis, they form a metering segment and may rotate on the same shaft or separate shafts. Preferably, there is one transverse row of metering elements, each metering element rotating around a separate axis of rotation and each metering element rotating on a separate shaft, thus the metering elements would not be on one single shaft, there would be one metering element per shaft and the metering elements would be operated side by side.

As discussed above, metering apparatuses of the prior art generally involve a meter roller assembly in which a plurality of meter rollers is rotated on a common shaft, all of the rollers rotating around a common transverse axis relative to the motion of the distribution implement. In contrast, each of the metering elements in the present invention rotate around an axis that is oriented non-transversely relative to the forward motion of the distribution implement and at least two of the metering elements rotate around a different axis of rotation.

In comparison to the prior art, the present invention allows better access to individual metering elements for repair and service and allows better control over each metering element. When metering elements are not on a common shaft, it is possible to dismantle one without needing to dismantle others when doing service or effecting repairs. A metering element can simply be pulled off and put back on its shaft without disturbing any other metering elements on the apparatus. It is advantageous that the metering element be pulled in a direction opposite to the drive input, to avoid the need to dismantle the drive input in order to change metering elements or remove a blockage of the metering element.

Further, metering elements may be controlled individually, rather than all together or in groups. Thus, each metering element may be turned on and off separately, using simpler control means than in prior art metering apparatuses. This permits an operator to sequentially or otherwise selectively switch off individual metering elements when approaching an irregular boundary, such as a water hole, in a field while towing the distribution implement. Because the implement must be towed to avoid the irregular boundary, parts of the implement will be towed over areas of the field in which agricultural product has already been deposited. It is desirable to avoid multiple applications of agricultural product to the same area of the field, both for reducing product waste and also for improving product performance by providing it at the correct dosage. By selectively determining the rate of application of agricultural product across a width of the agricultural implement, the present invention permits very fine control over where the agricultural product will be deposited, thus greatly reducing product waste and improving distribution patterns of the product in the field.

Agricultural product may include, for example, seed, fertilizer, pesticide, etc. Different types of agricultural product may be distributed separately or at the same time. It is a particular advantage that one implement can have multiple hoppers, each hopper containing different product and equipped with metering elements arranged in accordance with the present invention for simultaneous distribution of different agricultural product while having separate fine sectional control over the distribution of each type of product, all without unduly increasing complexity of the distribution system.

The drive input may be derived from any suitable source of mechanical power, for example a motor or motors. Motors include electric motors, hydraulic motors, stepper motors, internal combustion engines, etc. In some cases the power take-off from a towing vehicle may be used to drive the metering elements. In other cases, a ground driven wheel may be used to provide rotational movement of the drive input by virtue of forward travel of the implement along the field. The drive input may be coupled to the metering elements by any coupling means suitable for the type of drive input. Couplings include, for example, belt on pulley, chain on sprocket, directly linked drive shaft, etc. Belts or chains may be coupled to the pulleys or sprockets, respectively, in a simple loop or in a serpentine manner if more than one metering element is being driven by the same belt or chain.

A single drive input may be used in which case the same coupling is used for all the metering elements. More than one drive input may be used in which case one or more of the metering elements may be driven and controlled completely independently of others. Any combination of metering elements per drive input is possible, including having one metering element per drive input. In the case where there is only one metering element per drive input, the speed of the metering element may be conveniently controlled by directly controlling the speed of the drive input. In the case where two or more metering elements are driven by the same drive input, individual metering elements may be stopped by any suitable means, for example a simple clutch (e.g. electronic or mechanical), and the speed of an individual metering element may be controlled by any suitable control means, for example size of a sprocket or pulley on the metering element.

The flow rate of product to the field is dependent on the speed that the implement is being towed over the field. Turning the implement causes the implement to slow down on the inside of the turn and speed up on the outside of the turn. Therefore, it would be useful to be able to slow metering rate of product to the inside of the implement and speed up metering rate to the outside of the implement when the implement is turning. In the present invention, it is possible to accurately adjust metering rate at the metering element, since the speed of rotation of each metering element can be variably and independently controlled.

Metering elements may be housed in a hopper that receives agricultural product to be metered. Hoppers generally have a large opening for receiving product in bulk, and smaller apertures through which the product is metered by the metering elements. There may be one or more than one metering element associated with each aperture. Preferably there is one metering element per aperture. Hoppers may be equipped with other standard features, for example, covers, canopies, agitator bars and blocking plates for individual metering elements to prevent product from reaching individual metering elements.

Any rotatable metering element known in the art may be used in this invention. Meter rollers are preferred, for example pegged output rollers, fluted output rollers, high output rollers, etc. Two or more metering elements and any number of rows of metering elements may be used in a single hopper. For example, three or more, four or more, five or more metering elements may be used. One or more, two or more or three or more rows of metering elements may be used. The numbers will depend to an extent on the size of the distribution implement. From 1 to 5 rows and from 5 to 15 metering elements per row are preferred. For many applications, 1 row with from 6 to 12 metering elements in one hopper is suitable.

The metering apparatus may be used in conjunction with an agricultural product distribution system, for example an air cart where airflow is used to transport agricultural product through various air lines (e.g. hoses) and ports to outlet ports through which the product is deposited in soil. In such an air cart arrangement, the metering apparatus meters agricultural product into an airstream that carries the product to other parts of the distribution implement. Each airstream is generally carried in separate air lines. Individual metering elements are preferably oriented so that the axes of rotation of the metering elements are parallel to a direction of air flow in the airstream. There may be one or more than one metering element per airstream, so a single airstream may receive product from one or more than one metering element. Individual control of metering elements allows the separate metering elements to be of any length needed without restricting the transverse width of the apparatus. It is desirable for the overall transverse width of the apparatus to be as narrow as possible. This has the advantage of not having air lines spread out across a wide pattern transversely and then needing to transition them vertically across a hitch point to a narrow vertical group of lines. When an implement carrying the distribution system turns with a wide spread of lines across the hitching point, if the lines are too far from the pivoting point, the outer lines on one side will get stretched and may get pulled off the connections while the inner lines on the other side may kink.

Further, individual metering elements arranged in accordance with the present invention, instead of a plurality on one transverse shaft, has the advantage of being able to set each metering element speed individually. In the metering apparatus, each metering element is preferably (but not necessarily) associated with a separate aperture to a separate airstream. It is therefore possible to separately set the flow rate of product from each metering element into their respective separate airstreams. This can be accomplished by individual controllers, e.g. stepper motors, or by changing the size of pulleys or sprockets on each metering element to suit the speed in relation to the others as needed. There is often a need to distribute product to a different number of field rows per metering element, which can cause product distribution inaccuracies. For example, if there are 4 outlets on half of the metering elements and 5 outlets on the other half, there is a 20% variance per outlet. It is possible to compensate for this variation by changing the driven sprocket or pulley ratio to alter the product flow to equalize the metered amount of product per outlet.

Individual control over metering elements leads to the very useful ability to control the flow rate per line in both the transverse and longitudinal directions on the distribution implement thereby providing overall grid control in applying agricultural products at any given instant in time. Orienting the axis of rotation of the metering elements in a non-transverse direction combined with individual metering rate control, not just shut off, therefore permits variable flow rate of agricultural product across both the implement width (transversely) as well as in the direction of travelling motion of the implement (longitudinally) providing very accurate grid control over the distribution of agricultural product. The ability to combine both sectional control and variable rate is not present in and cannot be accomplished by prior art designs, for example the Amity Air Cart and the single shaft designs in US 2012/0325131, U.S. Pat. No. 8,132,521, U.S. Pat. No. 8,141,504 and U.S. Pat. No. 8,196,534.

As described herein, the metering apparatus in accordance with the present invention has a number of advantages. It permits selective deposition of agricultural product at certain parts of a distribution implement during product distribution. It can reduce complexity of sectional control of the metering apparatus. It can provide increased flexibility of control over individual metering elements in the metering apparatus. It can reduce complexity of servicing individual parts of the metering apparatus. Multiple hoppers can be used to distribute different agricultural product at the same time. And, it can reduce energy consumption during distribution of the agricultural product.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1A is a perspective view of a first embodiment of a metering apparatus of the present invention having one row of ten meter rollers, each roller having an axis of rotation oriented longitudinally and rotating on separate shafts;

FIG. 1B is an exploded view of FIG. 1A;

FIG. 1C is a transverse cross-section of FIG. 1A through the meter rollers shown in association with hoses on an agricultural product distribution implement;

FIG. 2A is a perspective view of a second embodiment of a metering apparatus of the present invention having one row of ten meter rollers, each roller having an axis of rotation oriented longitudinally and rotating on separate shafts;

FIG. 2B is a top view of the metering apparatus of FIG. 2A;

FIG. 2C is a side view looking longitudinally of the metering apparatus of FIG. 2A;

FIG. 2D is an end view looking transversely of the metering apparatus of FIG. 2A;

FIG. 2E is an exploded view of FIG. 2A;

FIG. 2F is a transverse cross-section of FIG. 2A through the meter rollers showing only one pair of meter rollers and shown in association with hoses on an agricultural product distribution implement;

FIG. 3A is a perspective view of a third embodiment of a metering apparatus of the present invention having one row of ten meter rollers, each roller having an axis of rotation oriented longitudinally and rotating on separate shafts;

FIG. 3B is a top view of the metering apparatus of FIG. 3A;

FIG. 3C is a side view looking longitudinally of the metering apparatus of FIG. 3A;

FIG. 3D is an end view looking transversely of the metering apparatus of FIG. 3A;

FIG. 3E is an exploded view of FIG. 3A; and,

FIG. 4 is a side view of an air cart comprising a metering apparatus of the present invention.

### DESCRIPTION OF PREFERRED EMBODIMENTS

With reference to FIGS. 1A and 1B, an embodiment of a metering apparatus of the present invention is shown having one transverse row of ten meter rollers spaced apart evenly along transverse axis T, each roller having an axis of rotation oriented longitudinally and rotating on separate shafts. The apparatus comprises meterbox shell 1 into which agricultural product is introduced in bulk through the top of the meterbox from a main bin (not shown). The meterbox shell has ten outlets in its bottom 2, each outlet associated with one meter roller unit 11a-11j. Each meter roller unit comprises pegged output roller 3 mounted fixedly on rotatable roller hex shaft 4, which can rotate within two bearing assemblies 8, the bearing assemblies being located front and back of the meter roller on the shaft. Also mounted on each shaft is meter roller unit sprocket 7 for receiving drive chain 12 and electric brake clutch 9 for disengaging the meter roller unit from the chain. Loading auger motor 5, which can be mounted on the meterbox shell, comprises motor sprocket 6 and drives all of the meter roller units in a counter-clockwise direction using the drive chain in a single-loop configuration.

As shown in FIG. 1C, and with reference to only one of the ten meter rollers, agricultural product (e.g. seed) sitting on bottom 2 of meterbox shell 1 is lifted by meter roller 3 above angled protruding lip 14 to fall through outlet 13 in the bottom of the meterbox shell. The outlet is simply an aperture in the bottom of the meterbox shell and the protruding lip a raised portion of the bottom next to the aperture. The product falls through the outlet into short vertical channel 15, and then into chamber 16 having air entry and exit ports oriented parallel to the roller shafts, i.e. longitudinally. Air flowing through chamber 16 from an air hose attached to the entry port and into an air hose attached to the exit port whisks the agricultural product away from the metering apparatus eventually to an outlet port on a product distribution implement (e.g. a seeding implement) where it is deposited into the soil. Because each meter roller unit comprises a simple clutch to disengage the unit from the drive chain, an operator can selectively stop operation of one or more individual meter rollers thereby halting the metering of product from the metering apparatus into the specific air hoses associated with those meter rollers. The selective stopping of one or more meter rollers can be accomplished manually with individual switches, or it can be accomplished automatically with software that makes use of GPS (global positioning system) mapping to switch off only those meter rollers supplying product to a part of the implement that has passed over a portion of the field that has already had product distributed therein.

With reference to FIGS. 2A-2E, another embodiment of a metering apparatus of the present invention is shown having one transverse row of ten meter rollers spaced apart in pairs along transverse axis TT, each roller having an axis of rotation oriented longitudinally and rotating on separate shafts. The apparatus comprises meterbox shell 20. The meterbox shell has ten outlets in its bottom 22, each outlet associated with one meter roller unit 21a-21j. Each meter roller unit comprises pegged output roller 23 mounted fixedly on rotatable roller hex shaft 24, which can rotate within two bearing assemblies 28, the bearing assemblies being located on one side of the meter roller on the shaft. Having two bearings on the shaft on the same side of the meterbox with an overhanging shaft configuration permits removal of meter rollers without removal of bearings or shaft, which is an even more preferred arrangement than the design shown in FIG. 1. Also mounted on each shaft is meter roller unit sprocket 27 for receiving drive chain 32 and electronic clutch 29 for disengaging the meter roller unit from the chain. The bearings, clutch and roller unit sprocket are mounted outside the meterbox shell on mounting flange 39 and shaft seal 30 seals the hole in the meterbox shell through which the shaft extends to the bearings. The pegged output roller is located within the meterbox shell and is associated with roller brush 31 for cleaning the roller. Alternatively to using a pegged output roller, fluted output roller 40a or high output roller 40b could be used. The meterbox shell is further equipped with removable rear cover 42 for easy access to the meter rollers for servicing and repair, canopy 33 for preventing product from escaping the meterbox through the top during operation, and agitator bar 35 for ensuring that product is constantly being moved to the bottom of the meterbox shell. Further, each pair of meter roller units is associated with overhead blocking plate 34 which can be slid into place over top of the meter rollers to prevent product from reaching the rollers from the box above. This facilitates inspection, servicing and repair of that pair of rollers without having to empty the meterbox of product and without having to disturb the other pairs of meter rollers. Hydraulic motor 25, mounted on the meterbox shell, comprises motor sprocket 26 and drives the meter roller units of each pair in opposite directions using the drive chain in a serpentine configuration and driving the chain in a clockwise direction.

As shown in FIG. 2F, and with reference to only one pair of the five pairs of meter rollers, agricultural product (e.g. seed) sitting on bottom 22 of meterbox shell 21 is lifted by meter rollers 23c and 23d above angled protruding lips 54c and 54d to fall through outlets 53c and 53d in the bottom of the meterbox shell. The outlets are simply apertures in the bottom of the meterbox shell and the protruding lips raised portions of the bottom next to the apertures. Because the chain is in a serpentine configuration and the chain is driven in a clockwise direction, meter roller 23c will rotate clockwise to move product to the left, while meter roller 23d will rotate counter-clockwise to move product to the right.

Similarly as described above, the product in FIG. 2F falls through the outlets into short vertical channels 55c,55d then into chambers 56c,56d having entry and exit ports oriented parallel to the roller shafts, i.e. longitudinally. Air flowing through air hoses whisks the agricultural product away from the metering apparatus eventually to outlet ports on a product distribution implement (e.g. a seeding implement) where it is deposited into the soil. Because each meter roller unit comprises a simple clutch to disengage the unit from the drive chain, an operator can selectively stop operation of one or more individual meter rollers thereby halting the metering of product from the metering apparatus into the specific air hoses associated with those meter rollers.

In both of the afore-described embodiments, controlling the speed of rotation of the meter rollers controls the amount of product metered out of the meterbox shell into the air hoses. In these embodiments, one motor drives all of the rollers and all of the roller units have the same size sprocket, so all of the rollers are driven at the same speed, except when the clutch of a roller is disengaged to stop the roller entirely.

With reference to FIGS. 3A-3E, yet another embodiment of a metering apparatus of the present invention is shown having one transverse row of ten meter rollers spaced apart in pairs, each roller having an axis of rotation oriented longitudinally and rotating on separate shafts. The apparatus comprises meterbox shell 60. The meterbox shell has ten outlets in its bottom 62, each outlet associated with one meter roller unit 61a-61j. In this embodiment, each meter roller unit is sprocketless as it is meant to be driven individually by its own stepper motor (not shown for clarity) for variable control of flow rate of agricultural product at each meter roller. Each meter roller unit comprises pegged output roller 63 mounted fixedly on rotatable roller hex shaft 64 that is driven by its own stepper motor. Each shaft can rotate within two bearing assemblies 68, the bearing assemblies being located on one side of the meter roller on the shaft. Having two bearings on the shaft on the same side of the meterbox with an overhanging shaft configuration permits removal of meter rollers without removal of bearings or shaft. Also mounted on each shaft is electronic clutch 69 for disengaging the meter roller from the stepper motor if desired. The bearings and clutch are mounted outside the meterbox shell and shaft seal 70 seals the hole in the meterbox shell through which the shaft extends to the bearings. The pegged output roller is located within the meterbox shell and is associated with roller brush 71 for cleaning the roller. Alternatively to using a pegged output roller, fluted output roller 80a or high output roller 80b could be used. The meterbox shell is further equipped with canopy 73 for preventing product from escaping the meterbox through the top during operation, and agitator bar 75 for ensuring that product is constantly being moved to the bottom of the meterbox shell. Further, each pair of meter roller units is associated with overhead blocking plate 74 which can be slid into place over top of the meter rollers to prevent product from reaching the rollers from the box above. This facilitates inspection, servicing and repair of that pair of rollers without having to empty the meterbox of product and without having to disturb the other pairs of meter rollers.

FIG. 4 depicts a metering apparatus of the present invention in the context of an air cart. For clarity, hoses have been omitted. Air cart 100 comprises frame 101 supporting tanks 102,103,104 for holding large supplies of agricultural product. For example, seed may be stored in tanks 102 and 104, while fertilizer in tank 103. The air cart rides on two wheels 105 (only one shown) and is towed with tow bar 106 hitched to a tractor through front hitch 107. Each of three metering apparatuses 110,112 (only two shown as the third is hidden by the wheel) located below the tanks each receive agricultural product from one of the tanks and meter the product into chambers in chamber blocks 111,113 (only two shown) associated with each metering apparatus. Air flow created by blower 115 flows through hoses (not shown) to carry agricultural product out of chambers in chamber blocks 111,113 through more hoses (not shown) and finally to a distribution implement being towed behind the air cart through a tow bar hitched to rear hitch 120.

The novel features of the present invention will become apparent to those of skill in the art upon examination of the detailed description of the invention. It should be understood, however, that the scope of the claims should not be limited by the preferred embodiments set forth in the examples, but should be given the broadest interpretation consistent with the specification as a whole.

1. A metering apparatus for distributing an agricultural product, comprising: a drive input; and, a plurality of metering elements coupled to the drive input to be rotatably driven by the drive input, each of the metering elements rotating around an axis of rotation and at least two of the metering elements rotating around different axes of rotation.

2. The apparatus according to claim 1, wherein every metering element rotates around a different axis of rotation.

3. The apparatus according to claim 1, wherein each metering element is rotated on a separate shaft so that there is one metering element per shaft.

4. The apparatus according to claim 1, wherein each axis of rotation has a metering segment comprising at least two metering elements rotating therearound.

5. The apparatus according to claim 4, wherein the at least two metering elements of each metering segment are rotated on a same shaft and each metering segment is rotated on a separate shaft.

6. The apparatus according to claim 1, wherein the axes of rotation of the metering elements are oriented non-transversely on the metering apparatus.

7. The apparatus according to claim 1, wherein the axes of rotation of the metering elements are oriented longitudinally and are spaced-apart transversely in respect of each other.

8. The apparatus according to claim 1, wherein the metering elements are operably associated with sprockets and coupled to the drive input by a chain that follows a serpentine path amongst the sprockets.

9. The apparatus according to claim 1, wherein the metering elements comprise meter rollers.

10. The apparatus according to claim 1, wherein the drive input comprises a motor.

11. The apparatus according to claim 1, wherein the rotation of each metering element is separately controllable to permit separate control over metering of the agricultural product from each metering element.

12. The apparatus according to claim 11, further comprising separate drive inputs for selectively controlling the rotation of each metering element.

13. The apparatus according to claim 11, wherein one or more of the metering elements is operably associated with a clutch for selectively stopping the rotation of the metering element.

14. The apparatus according to claim 1, comprising one row of 6-12 metering elements.

15. An agricultural product distribution system comprising the apparatus as defined in claim 1.

16. The system according to claim 15 comprising an air cart.

17. The system according to claim 16, wherein the air cart comprises at least one airstream flowing in a direction past the metering elements and into which the agricultural product is metered by the metering elements, the metering elements oriented so that the axes of rotation of the metering elements are parallel to the direction of flow of the at least one airstream past the metering elements.

18. The system according to claim 17, wherein the direction of flow of the at least one airstream past the metering elements is longitudinally oriented.

19. The system according to claim 17, comprising one metering element per airstream.

20. The system according to claim 17, comprising more than one metering element per airstream.

21. The system according to claim 17, wherein the at least one airstream flows in at least one air line.

22. A method of distributing an agricultural product in a field using a distribution implement, comprising: providing agricultural product to a plurality of rotating metering elements, each of the metering elements rotating around an axis of rotation and at least two of the metering elements rotating around different axes of rotation, each rotating metering element metering the agricultural product in an agricultural product distribution system on the distribution implement; and, distributing the agricultural product to the field.

23. The method according to claim 22, further wherein the agricultural product is metered into at least one airstream flowing in a direction past the metering elements.

24. The method according to claim 23, wherein there is one metering element per airstream.

25. The method according to claim 23, wherein the axes of rotation of the metering elements are parallel to the direction of air flow.

26. The method according to claim 22, wherein every metering element rotates around a different axis of rotation.

27. The method according to claim 22, wherein each metering element is rotated on a separate shaft so that there is one metering element per shaft.

28. The method according to claim 22, wherein the axes of rotation of the metering elements are parallel.

29. The method according to claim 28, wherein the axes of rotation of the metering elements are oriented non-transversely on the metering apparatus.

30. The method according to claim 28, wherein the axes of rotation of the metering elements are oriented longitudinally and spaced-apart transversely in respect of each other.

31. The method according to claim 22, comprising separately controlling the rotation of each metering element to permit separate control over the metering of the agricultural product from each metering element.
